(19) United States
(12) Patent Application Publication
(10) Pub. No.: US 2008/0136076 A1
(43) Pub. Date: Jun. 12, 2008

(54) Jounce Bumper Assembly

(75) Inventors: Neil S. Cummings, Ann Arbor, MI (US); Mikey L. Love, Londonderry, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/608,418

(22) Filed: Dec. 8, 2006

(51) Int. Cl. B60G 11/22; F16M 13/00

(52) U.S. Cl. 267/293; 267/292; 248/573; 248/615

(57) ABSTRACT

A jounce bumper assembly includes a bumper and a support member for supporting the bumper. The support member is made of a flexible material and is stiffer than the bumper. As the bumper is compressed, the support member is flexibly deformed and expands radially and at the same time limits the radial expansion of the bumper. The support member may have a base portion with a varied thickness. The base portion is also compressed as the bumper is compressed. The support member has the advantages of increasing the spring rate of the bumper to improve the load-carrying capability and providing a softer feel for occupants in a vehicle to which the jounce bumper assembly is mounted.

### FIELD

The present disclosure relates to suspension systems for motor vehicles, and more particularly to a jounce bumper assembly for use in a suspension system of a motor vehicle.

### BACKGROUND

The statement in this section merely provide background information related to the present disclosure and may not constitute prior art.

Jounce bumpers are often mounted on a strut assembly, as shown in U.S. Pat. No. 5,487,535, where a jounce bumper surrounds a piston rod of a strut suspension. The jounce bumper prevents the cylinder of the strut assembly from heavily impacting the strut mounting assembly. Jounce bumpers are also commonly mounted in other locations, as shown in U.S. Pat. No. 5,725,203, where the jounce bumper is free standing to prevent a control arm of the suspension system from impacting with the vehicle frame.

Jounce bumpers can be mounted in a free state or with a rigid cup. Commonly assigned U.S. Pat. No. 6,158,726 discloses a jounce bumper with the use of a rigid cup that is designed to be attached to the vehicle frame. The rigid cup acts to attach the jounce bumper to the vehicle (or alternatively the strut) and limits the jounce bumper distortion, thereby increasing its spring rate. As the jounce bumper is compressed, the force necessary to compress the jounce bumper increases and the jounce bumper absorbs the energy. When the resistance to compression increases to a point where the jounce bumper acts as a solid, the remaining energy from the impact is transferred to the vehicle. A rigid cup or another constraint used with the bumper limits the bulging of the bumper, thereby reducing the amount of travel needed to reach the point where the bumper becomes solid. In general, when more energy must be removed, a larger bumper is used.

While the use of a rigid cup is satisfactory in increasing the stiffness of the jounce bumper, there is a need for a jounce bumper assembly which provides a soft feel for occupants in a vehicle to which the jounce bumper assembly is mounted, while maintaining a desired spring rate and load-carrying capability of the jounce bumper assembly.

### SUMMARY

In one form, the jounce bumper assembly according to the teachings of the present disclosure includes a bumper, and a support member for supporting the bumper and adapted to be mounted to a motor vehicle. The support member is capable of being flexibly deformed while limiting a radial expansion of the bumper to increase a spring rate of the bumper as the bumper is compressed.

In another form, the jounce bumper assembly according to the teachings of the present disclosure includes a bumper, and a support member for supporting the bumper and adapted to be mounted to a motor vehicle. The support member includes a base portion, which is compressed and flexibly deformed as the bumper is compressed.

In still another form, the jounce bumper assembly according to the teachings of the present disclosure includes a bumper, a flexible support member for supporting the bumper, and a rigid cup surrounding the flexible support member. The flexible support member is compressed and flexibly deformed as the bumper is compressed.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of a jounce bumper assembly according to a first embodiment of the present disclosure;

FIG. 2 is a cross-sectional view of the jounce bumper, taken along line 2-2 of FIG. 1;

FIG. 3 is a cross-sectional view of a jounce bumper assembly according to a second embodiment of the present disclosure; and

FIG. 4 is a cross-sectional view of a jounce bumper assembly according to a third embodiment of the present disclosure.

Corresponding reference numerals indicate corresponding parts throughout the several views of the drawings.

### DETAILED DESCRIPTION OF THE PREFERRED EMBODIMENTS

The following description is merely exemplary in nature and is not intended to limit the present disclosure, application, or uses. It should be understood throughout the drawings, corresponding reference numerals indicate like or corresponding parts and features.

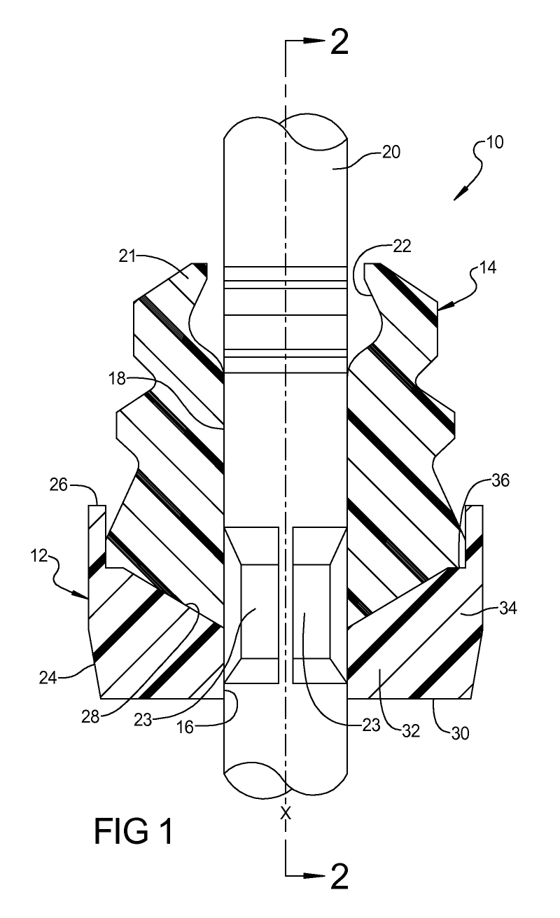

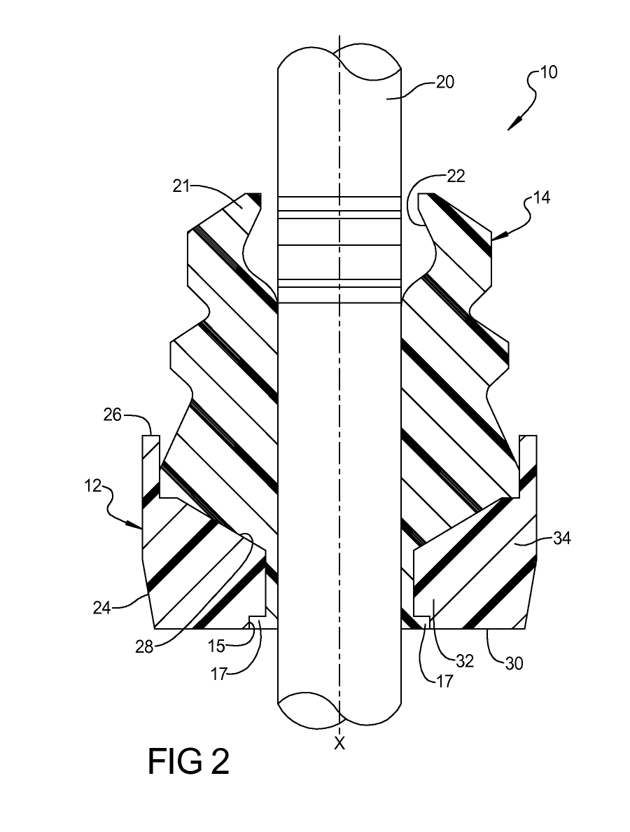

With reference to FIGS. 1 and 2, a jounce bumper assembly 10 according to a first embodiment of the present disclosure is shown. The jounce bumper assembly 10 is adapted to be mounted to a vehicle, and more specifically, can be mounted to a strut assembly (not shown) or in a free-standing position.

The jounce bumper assembly 10 includes a generally cup-shaped support member 12 and a bumper 14 supported by the support member 12. The bumper 14 can be made from any elastomeric material including microcellular urethane. The bumper 14 can be secured to the support member 12 by molding or any mechanical means known in the art. When a molding method is used, it is preferable that at least one counter bore 15 (shown in FIG. 2) is formed in the support member 12 to allow a part of the material of the bumper 14 to flow into the counter bore 15 to form at least one extension 17 during molding, thereby increasing the bonding between the bumper 14 and the support member 12. As a result, the bumper 14 and the support member 12 are molded into one piece. The extension 17 of the bumper 14 also provides proper alignment of the bumper 14 relative to the support member 12 during compression.

The support member 12 defines a central bore 16 and the bumper 14 defines a central bore 18. The central bores 16 and 18 allow for passage of a piston rod 20 of a strut assembly (not shown) so that the bumper 14 can be compressed axially along the piston rod 20 as a striker (not shown) contacts and compresses the bumper 14. As is known in the art, the striker is mounted around the piston rod 20 and is moved to contact and compress the bumper 14 along the axial direction X of the piston rod 20 by the strut assembly.

Alternatively, the central bores 16 and 18 can receive a mounting bolt, nut, any fastener, which mounts the jounce bumper 10 to the vehicle frame, as is known in the art.

The bumper 14 includes a recess 22 at an end portion 21 of the bumper 14 proximate to the striker. The recess 22 is formed by removing a part of the material from the bumper 14. The recess 22 reduces the spring rate of the bumper 14 for the initial contact between the striker and the bumper 14.

The jounce bumper assembly 10 comprises retention features 23 extending from the bumper 14 to the piston rod 20. The retention features are a part of the bumper 14. As the bumper 14 is assembled onto the piston rod 20, the piston rod 20 compresses the retention features 23 and holds the retention features 23 and hence the bumper 14 in place. The retention features 23 can be in the form of a continuous bump or separate bumps extending radially and inwardly from the bumper 14 toward the piston rod 20.

The support member 12 includes a base portion 24 and a cylindrical sidewall 26 extending from the base portion 24 at an outer periphery of the base portion 24 in a direction parallel to the longitudinal axis X. The base portion 24 has a tapered surface 28 and a bottom surface 30 opposite to the tapered surface 28. The tapered surface 28 and the bottom surface 30 define a varied thickness of the base portion 24 such that a thinner portion 32 is disposed proximate to the central bore 16 and a thicker portion 34 is disposed proximate to the cylindrical sidewall 26. An annular step 36 is defined between the tapered surface 28 and the cylindrical sidewall 26. The support member 12 is made of a flexible material, preferably an elastomer, and is stiffer than the bumper 14.

The dimensions of the jounce bumper assembly 10 can be varied to adjust the rate curve for the system. For example, the dimensions of the support member 12 can be varied depending on the desired spring rate curve for the jounce bumper assembly 10.

In operation, as an impact is applied by the strut assembly to the striker, the striker compresses the bumper 14 and causes the bumper 14 to compress axially and expand radially against the cylindrical sidewall 26. Because the support member 12 is made of a flexible material, the support member 12 is flexibly deformed and expands radially with the bumper 14, thereby providing a softer feel for the occupants in the vehicle. At the same time, because the support member 12 is stiffer than the bumper 14 and has a smaller range of deformation/radial expansion than the bumper 14, the support member 12 limits the radial expansion of the bumper 14 to increase the spring rate of the bumper 14. When the bumper 14 is compressed, the support member 12 is also compressed in a direction parallel to the longitudinal axis X. Therefore, the stiffer support member 12 also contributes to the overall stiffness of the jounce bumper assembly when the support member 12 is compressed.

The materials for the support member 12 should be elastic enough to allow for a predetermined amount of radial expansion and axial displacement with minimal permanent deformation and should be stiff enough to increase the load-carrying capability for the bumper. Generally speaking, minimal radial expansion of the support member is desirable. Materials such as solid urethanes and elastomers are preferable for the support member 12 depending on applications.

The varied-thickness configuration of the support member 12 has an advantage of further increasing the spring rate of the bumper 14. The thicker portion 34 of the base portion 24 proximate to the cylindrical sidewall 26 limits the axial compression of the bumper 14, thereby further increasing the spring rate of the bumper 14.

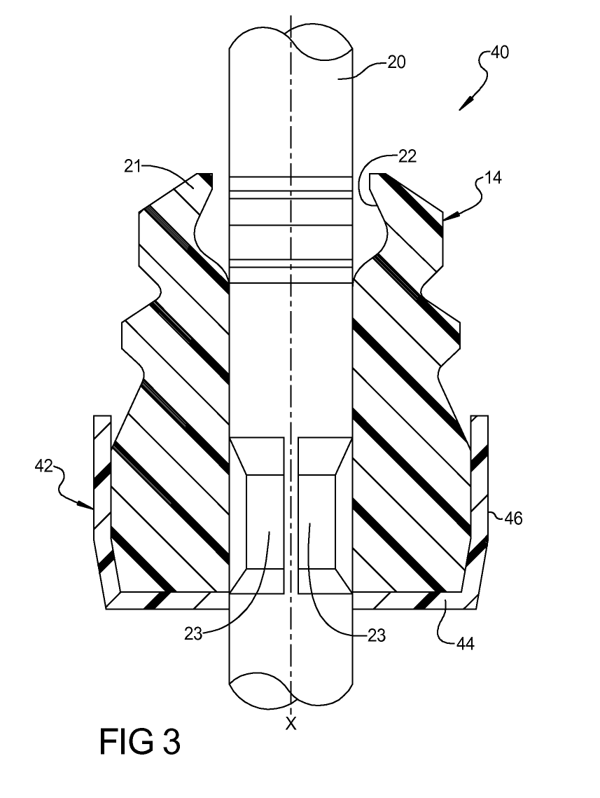

Referring to FIG. 3, a jounce bumper assembly in accordance with a second embodiment of the present disclosure is illustrated and generally indicated by reference numeral 40. The jounce bumper assembly 40 includes a bumper 14 and a support member 42 for surrounding and supporting the bumper 14. Unlike the support member 12 of FIG. 1, the support member 42 includes a base portion 44 having a uniform thickness and a cylindrical sidewall 46 extending from the base portion 44 and surrounding the bumper 14. The cylindrical sidewall 46 is relatively larger than the cylindrical sidewall 26 in FIG. 1. This configuration allows for a larger amount of deformation/radial expansion of the support member 42 to provide a softer feel compared with the configuration of FIG. 1. The spring rate of the bumper 14 and the soft feel to the occupants can be balanced by properly choosing the materials for the support member and the bumper and the configuration of the support member.

The jounce bumper assemblies 10 and 40 in accordance with the present disclosure provide a balance between a desired impact capability and a soft feel for the occupants in the vehicle. By using a flexible material for the support member, which is stiffer than the bumper, the jounce bumper assembly creates a softer feel for the occupants and at the same time limits the radial expansion of the bumper to increase the spring rate of the bumper and to increase the load-carrying capability.

Further, the spring rate of the bumper can be further increased by providing a thicker portion at the base portion of the support member to reduce the functional height of the jounce bumper. The functional height of the jounce bumper refers to the height of the bumper 14 from an end proximate to the striker to an end proximate to the support member 12. With the shorter functional height at the thicker portion, the spring rate of the jounce bumper at the thicker portion increases at a higher rate than the remainder of the bumper. The varied thickness of the base portion of the support member can be properly chosen depending on a predetermined load-carrying capability and the desired soft feel.

It should be understood and appreciated that while the support member has been described and illustrated as a generally cup-shaped member, the support member can be of any configuration and shape without departing from the scope of the present disclosure as long as the support member can limit the radial expansion of the bumper to increase the spring rate of the bumper and can be flexibly deformed to increase a softer feel. With the use of the support member, the functional height of the jounce bumper for a predetermined jounce bumper height can be reduced compared with a jounce bumper without a support member. This increases the block height for the given overall jounce bumper height. A block height refers to the height of the jounce bumper assembly when the jounce bumper assembly has undergone compression to the maximum load for the application.

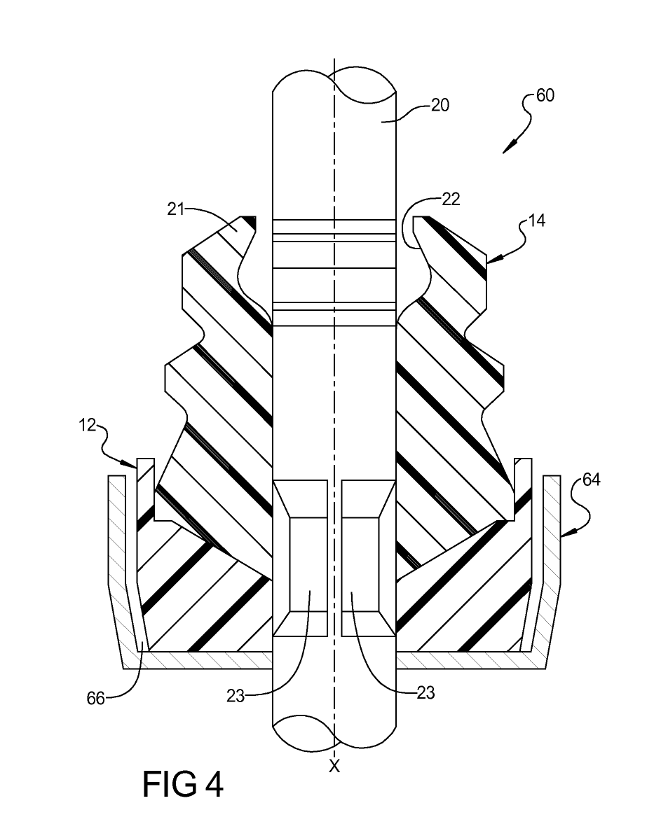

Referring to FIG. 4, a jounce bumper assembly in accordance with a third embodiment of the present disclosure is illustrated and generally indicated by reference numeral 60. The jounce bumper assembly 60 includes a bumper 14, a support member 12 for surrounding and supporting the bumper 14, and a rigid cup 64 surrounding the support member 12. A gap 66 can be formed between the support member 12 and the rigid cup 64. The rigid cup 64 limits the radial expansion of the support member 12 as the bumper 14 and the support member 12 are compressed, thereby further increasing the spring rate and the energy absorption characteristics of the jounce bumper assembly 60.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A jounce bumper assembly comprising:
a bumper; and
a support member for supporting the bumper,
wherein the support member is capable of being flexibly deformed while limiting a radial expansion of the bumper to increase a spring rate of the bumper as the bumper is compressed.

2. The jounce bumper assembly of claim 1, wherein the support member comprises a flexible material.

3. The jounce bumper assembly of claim 1, wherein the support member comprises an elastomer stiffer than the bumper.

4. The jounce bumper assembly of claim 1, wherein the support member includes a generally-cup shaped configuration.

5. The jounce bumper assembly of claim 1, wherein the support member includes a base portion and a cylindrical sidewall extending from the base portion.

6. The jounce bumper assembly of claim 5, wherein the cylindrical sidewall is flexibly deformed as the bumper is compressed.

7. The jounce bumper assembly of claim 5, wherein the base portion has a uniform thickness.

8. The jounce bumper assembly of claim 5, wherein the base portion has a varied thickness.

9. The jounce bumper assembly of claim 5, wherein the base portion defines a thicker portion proximate to the cylindrical sidewall and a thinner portion proximate to a center of the base portion.

10. The jounce bumper assembly of claim 1, further comprising a piston rod extending through the bumper and the support member.

11. The jounce bumper assembly of claim 1, further comprising a rigid cup surrounding the support member.

12. The jounce bumper assembly of claim 1, wherein the bumper is formed of microcellular urethane.

13. The jounce bumper assembly of claim 1, wherein the bumper and the support member are molded into one piece.

14. The jounce bumper assembly of claim 1, wherein the support member defines at least one counter bore into which a part of the bumper extends.

15. A jounce bumper assembly comprising:
a bumper; and
a support member for supporting the bumper, the support member including a base portion,
wherein the base portion is compressed and flexibly deformed as the bumper is compressed.

16. The jounce bumper assembly of claim 15, wherein the support member is made of a flexible material.

17. The jounce bumper assembly of claim 15, wherein the support member is stiffer than the bumper.

18. The jounce bumper assembly of claim 15, wherein the support member is generally cup shaped.

19. The jounce bumper assembly of claim 15, wherein the base portion of the support member has a varied thickness.

20. The jounce bumper assembly of claim 15, wherein the base portion has a thicker portion proximate to an outer periphery of the base portion and a thinner portion proximate to a center of the base portion.

21. A jounce bumper assembly comprising:
a bumper;
a flexible support member for supporting the bumper; and
a rigid cup surrounding the flexible support member,
wherein the flexible support member is compressed and flexibly deformed as the bumper is compressed.

22. The jounce bumper assembly of claim 21, wherein the jounce bumper assembly defines a gap between the flexible support member and the rigid cup.

23. The jounce bumper assembly of claim 21, wherein the rigid cup limits a radial expansion of the flexible support member.
